(19) United States
(12) Patent Application Publication
(10) Pub. No.: US 2011/0070458 A1
(43) Pub. Date: Mar. 24, 2011

(54) MAGNESIUM ALLOY HONEYCOMB BOARD AND PREPARATION METHOD THEREOF

(75) Inventors: Gaofeng Quan, Liaoning (CN); Heling Zhou, Liaoning (CN)

(73) Assignees: DALIAN JIAOTONG UNIVERSITY, LIAONING (CN); YINGKOU YINHE MAGNESIUM AND ALUMINUM ALLOY CO., LTD, LIAONING (CN); BEIJING WONDERROAD MAGNESIUM TECHNOLOGY CO., LTD., BEIJING (CN)

(21) Appl. No.: 12/991,910

(22) PCT Filed: May 8, 2009
(86) PCT No.: PCT/CN2009/071692

§ 371 Date: Dec. 6, 2010

(30) Foreign Application Priority Data
May 9, 2008 (CN) 200810011370.X

(51) Int. Cl. B32B 3/12

(52) U.S. Cl. 428/593

(57) ABSTRACT

The present invention relates to a magnesium alloy honeycomb board and a production process thereof. The magnesium alloy honeycomb board is formed through the glue-jointing of an upper panel, a lower panel and a honeycomb core structure, and is characterized in that: both the upper and lower panels are made of magnesium alloy sheets with a thickness of 0.6 to 3.5 mm, and the honeycomb core structure is made of magnesium alloy foil with a thickness of 0.08 to 0.25 mm; the thickness of the honeycomb board is within 8 to 45 mm, the thickness of the honeycomb core structure is within 6 to 38 mm, the height of the hexagonal honeycomb aperture is within 5 to 15 mm, and the fillet radius is within 0.4 to 1.2 mm. The honeycomb core structure is a regularly-hexagonal one formed through the rolling, cutting, plastic bending, accurate forming and positioned bonding of high-strength magnesium alloy, and is then glue-jointed with the high-strength magnesium alloy panels to form the magnesium alloy honeycomb board with high strength and ultra-light weight through pressurizing solidification. Being capable of realizing the weight reducing effect, the magnesium alloy honeycomb board not only can be used as components like wallboard, floor, partition board, etc. in such transportation equipment as spacecrafts, aircrafts, light-weight rapid trains, urban railway trains, etc., but also can be applied in other structures as panel or partition board.

### FIELD OF THE TECHNOLOGY

The present invention relates to a honeycomb structure made of metal, in particular to a magnesium alloy honeycomb board and a production process thereof.

### BACKGROUND

A honeycomb board is a light weight mechanical engineering structure with high bending and compression strength, and is setup through bonding an upper panel, a lower panel and a honeycomb core in between.

Common honeycomb boards at present include the following three types: paper honeycomb board, glass fiber reinforced plastic honeycomb board and aluminum honeycomb board. Honeycomb cores of the paper honeycomb board are formed through gluing of impregnated paper resin and composite boards of plant or synthetic polymers; with low cost and low strength, the paper honeycomb board cannot endure dampness and is therefore only used for such structures as light-duty mobile houses; being made of composite materials of glass fiber and resin, the glass fiber reinforced plastic honeycomb board has the characteristics of light weight and high strength, but meanwhile has the disadvantages of possessing low impact strength, being easily aged and using unrecyclable resources; being formed through the glue-jointing of aluminum honeycomb cores and aluminum alloy sheets, the aluminum honeycomb board has higher strength as well as good weather resistance, and is already applied as floor and walls of airplanes, rapid trains and so on.

Along with the development in light weight of transportation equipment, many original aluminum alloy structures are faced with the requirement of further weight reduction, and the aluminum honeycomb board cannot meet the new need any more due to its more weight.

Performances of aluminum alloy and magnesium alloy for manufacturing the honeycomb board are compared, and see Table 1 below for relevant parameters:

TABLE 1

| | | Vickers | Yield | |
|---|---|---|---|---|
| | Density | hardness | strength | Specific |
| Material | (g/cm³) | (HV) | (MPa) | strength |
| Aluminum | 2.75 | 45 to 60 | 80 to 200 | 29.1 to 72.7 |
| alloy 5083 | | | | |
| Magnesium | 1.76 | 55 to 75 | 120 to 230 | 68.2 to 130.7 |
| alloy AZ31B | | | | |

Obviously, magnesium alloy is much lighter in weight and especially has the advantage of specific strength much higher than aluminum alloy. The accurate bending and forming of magnesium alloy foil are rather difficult, while the honeycomb board requires regularly-hexagonal honeycomb cores to achieve the mechanical strength for the bearing effect to the maximum degree; therefore, the forming parameters and process of the magnesium alloy foil are required to be accurately formed and assembled so as to meet the requirements for the structure and performance of the honeycomb board.

### SUMMARY

Considering that various existing honeycomb boards cannot meet the new need of higher performance and lighter weight due to various disadvantages, the present invention aims at disclosing a magnesium alloy honeycomb board; meanwhile, in view of the accurate forming difficulty of the magnesium alloy foil, the present invention further discloses a production process of the magnesium alloy honeycomb board so as to meet the requirement for the structure and performance of the honeycomb board.

The technical solution of the present invention is realized as below:

A magnesium alloy honeycomb board is formed through the glue-jointing of an upper panel, a lower panel and a honeycomb core in between, and is characterized in that both the upper and lower panels are made of rolled magnesium alloy sheets and the honeycomb core structure is a hexagonal one formed through accurate formation of magnesium alloy foils.

The thickness of the honeycomb board is within 8 to 45 mm, wherein the thickness of the upper and lower panels is respectively within 0.6 to 3.5 mm, the height of the hexagonal honeycomb aperture of the honeycomb core structure is within 5 to 15 mm, the fillet radius is within 0.4 to 1.2 mm, and the thickness and width of the magnesium alloy foil for manufacturing the honeycomb core structure are respectively within 0.08 to 0.25 mm and within 6 to 38 mm.

A production process of the magnesium alloy honeycomb board, including the manufacturing process of the honeycomb core structure, the preparation process of the panels, the glue-jointing combination of the honeycomb core structure with the panels, the forming process of the honeycomb board through pressurizing solidification, and the surface treatment process according to the requirement; and characterized in that the manufacturing process of the honeycomb core structure includes the following steps:

(1) Rolling the magnesium alloy with hot or cold process as foil: the magnesium alloy is rolled into a foil tape with a thickness of 0.08 to 0.25 mm;

(2) Cutting the magnesium alloy foil into tape: the magnesium alloy foil is cut into a foil tape with a width of 6 to 38 mm according to the design requirement of the honeycomb board;

(3) Bending the magnesium alloy foil tape accurately and undamagedly to form a honeycomb core blank: after plastic formation for angle defining, the formed fillet radius is within 0.4 to 1.2 mm, and correspondingly the forming strain rate is within 0.01 to 0.00001/s; and the fillet radius of the plastic formation for angle defining is not larger than 1.2 mm but meanwhile needs to be as large as possible in order to ensure no damage to materials;

(4) Assembly positioning, bonding and solidifying the honeycomb core blank to form the honeycomb core structure: the thickness of the manufactured honeycomb core structure is within 6 to 38 mm, and the height of the hexagonal honeycomb aperture is within 5 to 15 mm.

Compared with the prior technique, the magnesium alloy honeycomb board of the present invention is neither lower nor higher than the aluminum honeycomb board with the same specifications in strength, the former is 25 to 33% lower than the latter in weight of unit area, and is over 20% higher than the latter in compression strength. Being capable of achieving obvious weight reducing effect, the magnesium alloy honeycomb board not only can be used as components like wallboard, floor, partition board, etc. in such transportation equipment as spacecrafts, aircrafts, light-weight rapid trains, urban railway trains, busses, etc., but also can be applied in other structures as panel or partition board. If being used as the floor of a new-generation underground train and combined with a magnesium alloy skeleton, the magnesium alloy honeycomb board will achieve an effect of over 25% lighter than the present aluminum alloy structure, thereby solving the problem of overweight built-in structure of the railway train, realizing great reduction in weight, noise and vibration, obviously increasing the overall train manufacturing and operating efficiency, improving the boarding conditions, and realizing human-oriented traffic.

### BRIEF DESCRIPTION OF THE DRAWINGS

FIG. 1 indicates the foil tape rolled and cut into certain thickness and width;

FIG. 2 indicates the honeycomb core blank formed through accurate and intact bending forming the magnesium alloy foil;

FIG. 3 indicates the honeycomb core structure formed through the stacking and bonding of the honeycomb core blank;

FIG. 4 indicates the honeycomb board formed through the glue-jointing combination and solidification of the panels with the honeycomb core.

In the figures,

1—honeycomb core structure

2—upper panel

3—lower panel

### DETAILED DESCRIPTION

Further detailed description about the present invention is made below combining with the schematic diagram for the production process of the magnesium alloy honeycomb board:

(1) Manufacturing the honeycomb core structure 1: magnesium alloy such as AZ31B is manufactured into foil of a thickness of 0.08 to 0.25 mm through hot or cold rolling, and processing parameters of the foil after heat treatment and surface treatment are shown in Table 1; as shown in FIG. 1, the foil is cut into tapes with a width of 6 to 38 mm;

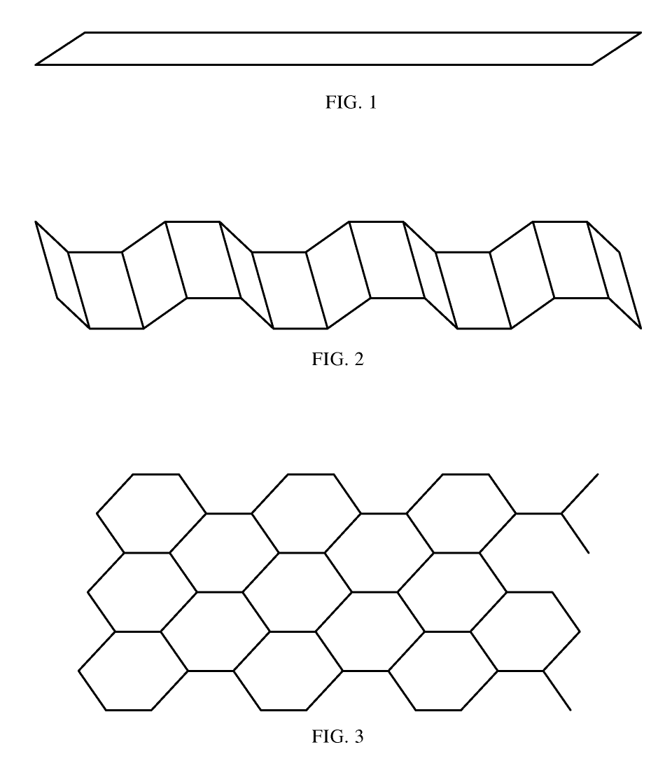

The foil tape is then shaped into the honeycomb core blank through accurate and intact bending forming; as shown in FIG. 2, the formed fillet radius is 0.4 mm, and correspondingly the forming strain rate is 0.0015/s;

As shown in FIG. 3, the formed honeycomb core blank is placed on a working platform and is then solidified into the regularly-hexagonal honeycomb core structure 1 with a thickness of 6 to 38 mm under a designated temperature of 80 to 120 and a designated pressure of 0.3 to 1.0 MPa after glue sizing, positioning and stacking, and the height of the regularly-hexagonal aperture is within 5 to 15 mm;

(2) Preparing the upper panel 2 and the lower panel 3: magnesium alloy with the same or different components is adopted to be rolled into sheets, and hot-rolled or cold-rolled sheets are selected according to the application requirement; such alloys as AZ31B, AZ41 or ZK60 can be selected as materials according to the requirements of users, and the thickness and breadth of the alloys are respectively within 0.6 to 3.5 mm and 450 to 1,250×600 to 3,000 mm; and glue sizing is carried out on the alloy for standby use after surface treatment;

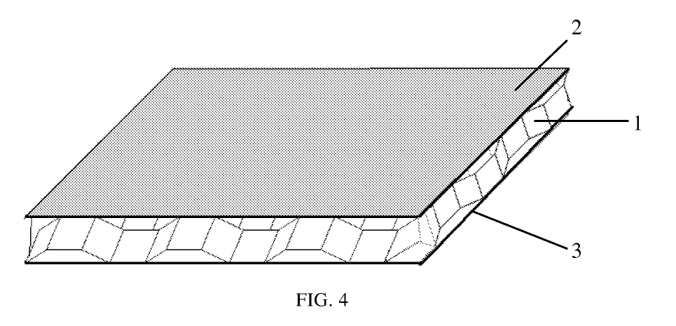

(3) Glue-jointing combining the honeycomb core structure 1 with the upper panel 2 and the lower panel 3: as shown in FIG. 4, glue sizing and pressurizing solidification are carried out between the honeycomb core structure 1 and the upper panel 2 as well as the lower panel 3, so as to form the honeycomb board with a thickness of 8 to 45 mm and a breadth the same as that of the panels;

(4) Making surface treatment according to the requirement: for example, anodic oxidation is carried out to achieve higher surface hardness and better wear resistance as well as good corrosion resistance.

The upper panel, the lower panel and the honeycomb core structure of the magnesium alloy honeycomb board of the present invention all adopt magnesium alloy, and the honeycomb core structure with regularly-hexagonal honeycomb holes is formed through the cutting, plastic bending, accurate forming and positioned bonding of the rolled high-strength magnesium alloy foil; after being glue-jointed together, the honeycomb core structure and the high-strength magnesium alloy sheets form the magnesium alloy honeycomb board with high strength and ultra-light weight through elevated temperature pressurizing solidification or room temperature solidification.

The above are only the preferred embodiments of the present invention, to which the protective range of the present invention is not limited; and any equivalent replacement or modification made by technical personnel familiar with this technical field within the technical range disclosed by the present invention according to the technical solution and the inventive concept thereof should all be included within the protective range of the present invention.

What is claimed is:

1. A magnesium alloy honeycomb board, formed through the glue-jointing of an upper panel, a lower panel and a honeycomb core structure; and characterized in that: the upper panel and the lower panel are both made of rolled magnesium alloy sheets, and the honeycomb core structure is a hexagonal one formed through accurate plastic formation of magnesium alloy foil.

2. The magnesium alloy honeycomb board according to claim 1, characterized in that: a thickness of the honeycomb board is within 8 to 45 mm, wherein a thickness of the upper and lower panels is respectively within 0.6 to 3.5 mm, a height of a hexagonal honeycomb aperture of the honeycomb core structure is within 5 to 15 mm, a fillet radius is within 0.4 to 1.2 mm, and a thickness and width of the magnesium alloy foil for manufacturing the honeycomb core structure are respectively within 0.08 to 0.25 mm and within 6 to 38 mm.

3. A production process of the magnesium alloy honeycomb board according to claim 2, comprising a manufacturing process of a honeycomb core structure, a preparation process of panels, a glue-jointing combination of a honeycomb core structure with the panels, a forming process of a honeycomb board through pressurizing solidification, and a surface treatment process according to the requirement; and characterized in that the manufacturing process of the honeycomb core structure comprises the following steps:
(1) Rolling a magnesium alloy fillet with hot or cold rolling process, wherein the magnesium alloy is rolled into a foil with a thickness of 0.08 to 0.25 mm;
(2) Cutting the magnesium alloy foil, wherein the magnesium alloy foil is cut into foil tapes with a width of 6 to 38 mm according to the design requirement of the honeycomb board;
(3) Bending forming the magnesium alloy foil tapes accurately and intactly, wherein after plastic formation for angle defining, a formed fillet radius is within 0.4 to 1.2 mm, and correspondingly a forming strain rate is within 0.01 to 0.00001/s;
(4) Laminately positioning, glue-sizing, bonding and solidifying a honeycomb core blank to form the said honeycomb core structure, wherein a thickness of a manufactured honeycomb core structure is within 6 to 38 mm, and a height of a hexagonal honeycomb aperture is within 5 to 15 mm.
